(19) United States
(12) Patent Application Publication
(10) Pub. No.: US 2023/0132606 A1
(43) Pub. Date: May 4, 2023

(54) PARTICLE SUCTION NOZZLE FITTED WITH A FASTENING SYSTEM COMPRISING AT LEAST ONE TUBULAR INSERT MADE OF ELASTICALLY DEFORMABLE MATERIAL, AND SUCTION DEVICE COMPRISING SAID NOZZLE

(71) Applicant: Airbus Operations (S.A.S.), Toulouse (FR)

(72) Inventors: Laurent Talou, Toulouse (FR); Yannick Kaufling, Toulouse (FR)

(21) Appl. No.: 17/973,957

(22) Filed: Oct. 26, 2022

(30) Foreign Application Priority Data
Oct. 28, 2021 (FR) 2111459

(51) Int. Cl. A47L 9/06; A47L 7/00

(52) U.S. Cl. CPC A47L 9/0693; A47L 7/0095; B23Q 11/0046

(57) ABSTRACT

A particle suction nozzle including a body that has a suction mouth as well as at least a portion of a fastening system designed to link the nozzle to a support. The fastening system has at least one tubular insert made of elastically deformable material rigidly connected to the body and designed to be fitted onto a linking element rigidly connected to the support, and once fitted, to be immobilized in relation to the linking element and at a distance from the support. A suction device includes the suction nozzle.

### TECHNICAL FIELD

The disclosure herein relates to a particle suction nozzle fitted with a fastening system comprising at least one tubular insert made of elastically deformable material, as well as a suction device comprising the nozzle.

### BACKGROUND

According to one embodiment described in document FR3022813, a particle suction device includes a suction generator and a particle suction nozzle connected to the suction generator by a pipe. This suction device is notably used to aspirate particles produced during machining or fitting operations during assembly of an aircraft.

According to this embodiment, the suction nozzle has a suction mouth through which the particles are aspirated, as well as a depression fastening system comprising a suction cup. Furthermore, the suction generated by the suction generator enables both the aspiration of particles via the suction mouth and the depression of the suction cup to fasten the nozzle to the part to be machined.

According to this embodiment, the surface on which the suction cup is positioned has to be flat to install the suction cup. In parallel, to ensure maximum efficiency, the suction mouth has to be positioned close to the zone where the particles are generated. In some cases, such as the machining of holes in an angle iron, the geometry of the part makes the optimal positioning of the suction nozzle difficult.

The disclosure herein is intended to overcome some or all of the drawbacks in the prior art.

### SUMMARY

For this purpose, the disclosure herein relates to a particle suction nozzle comprising a body having a first face, a cavity opening out in the first face to form a suction mouth as well as a connection tube communicating with the cavity, the suction nozzle having at least one portion of a fastening system designed to link the nozzle to a support.

According to the disclosure herein, the fastening system has at least one tubular insert made of elastically deformable material, rigidly connected to the body, the insert forming a seat designed to receive a linking element rigidly connected to the support, the insert and the linking element forming a tight fit to enable the insert to be fitted on the linking element, the insert, once fitted, being immobilized in relation to the linking element and at a distance from the support.

The use of at least one elastomer tubular insert fitted onto a linking element enables the suction mouth to be positioned near to the zone to be machined, even if the surface about the zone is not flat.

According to one feature, each insert has an outer wall. Additionally, the body has, for each insert, a through-hole that has a first section opening out in the first face and having an inner wall cooperating with the outer wall of the insert and a second section having a diameter less than the diameter of the first section, the first and second sections being linked by a shoulder.

According to another feature, the length of the first section is substantially equal to the length of the insert so that the insert is flush with the first face when in contact with the shoulder.

According to another feature, the suction mouth has an oblong shape as well as first and second ends. Furthermore, the fastening system has two inserts positioned at the ends of the suction mouth as well as two linking elements each designed to be rigidly connected to the support and to cooperate with one of the two inserts.

According to another feature, the body comprises first and second heads positioned on each side of the suction mouth and extending the first and second ends thereof, in which the inserts are positioned.

According to another feature, the connection tube is positioned to extend the cavity in a direction perpendicular to the first face.

The disclosure herein also relates to a suction device comprising a particle suction nozzle according to one of the preceding features.

According to another feature, the suction device includes, for each insert, a linking element designed to be rigidly connected to the support and to be seated in the seat formed by the insert.

According to another feature, each linking element is an assembly pin.

According to another feature, each linking element comprises a cylindrical body that extends between the first and second ends, the cylindrical body having a first shoulder positioned at the first end thereof and designed to bear against a surface of the support.

According to another feature, the cylindrical body has a second shoulder parallel to the first shoulder and separated by a given distance from the first shoulder, the cylindrical body having a first diameter from the second shoulder in the direction of the second end as well as a second diameter, that is greater than the first diameter, from the second shoulder in the direction of the first end.

According to another feature, each linking element has at least one slightly tapered section between the first and second ends with a diameter that lessens towards the second end.

### BRIEF DESCRIPTION OF THE DRAWINGS

Other features and advantages are set out in the description of the disclosure herein below, given purely by way of example and with reference to the attached drawings, in which:

FIG. 1 is a perspective view from a first viewing angle of a suction nozzle according to one embodiment of the disclosure herein;

FIG. 2 is a perspective view from a second viewing angle of the suction nozzle shown in FIG. 1;

FIG. 3 is a cross section taken along the plane P1 of the suction nozzle shown in FIG. 1;

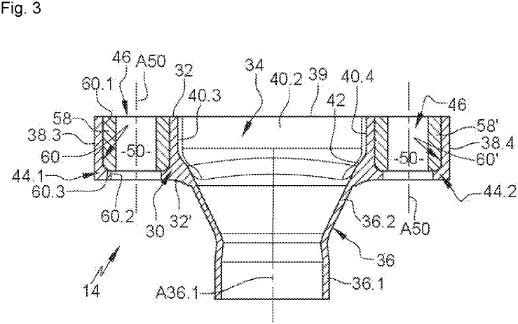

FIG. 4 is a perspective view of a suction nozzle being fastened to a support showing one embodiment of the disclosure herein;

FIG. 5 is a side view of a suction nozzle fastened to a support showing one embodiment of the disclosure herein; and

FIG. 6 is a cross section taken along the plane P2 of the suction nozzle shown in FIG. 5.

### DETAILED DESCRIPTION

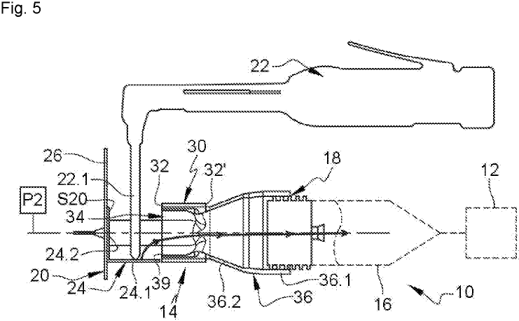

According to one embodiment shown in FIG. 5, a particle suction device 10 includes a suction generator 12, a suction nozzle 14, and a pipe 16 inking the suction nozzle 14 and the suction generator 12. According to one arrangement, the suction nozzle 14 is linked to the pipe 16 by a removable connection system 18. The suction generator 12, the pipe 16 and the connection system 18 are not further described as they are known to the person skilled in the art.

According to one application, this particle suction device 10 is notably used to aspirate particles produced during a stock removal operation, such as machining or fitting operations on a panel during assembly of an aircraft.

According to this application, the suction nozzle 14 is fastened to a support 20 on which a tool 22 has to perform at least one stock removal operation. The tool 22 has an active part 22.1, such as a drill, to perform the stock removal operation, such as drilling at least one hole 20.1. The support 20 has an L-shaped angle iron 24 with a first flange 24.1 and a second flange 24.2, the hole or holes 20.1 being positioned on the first flange 24.1. According to one arrangement, the support 20 includes, in addition to the L-shaped angle iron 24, a wall 26 against which the second flange 24.2 is pressed. The L-shaped angle iron 24 is held on the wall 26 by at least one linking element 28 such as a rivet or an assembly pin.

The suction nozzle 14 includes a body 30 that has a first face 32 and a cavity 34 opening out in the first face 32 as well as a connection tube 36 that has a first cylindrical end 36.1 and a second end 36.2 communicating with the cavity 34.

In the remainder of the description, a longitudinal direction is a direction perpendicular to the first face 32. A transverse direction is a direction perpendicular to the longitudinal direction. A transverse plane is a plane perpendicular to the longitudinal direction.

The first cylindrical end 36.1 is designed to connect the pipe 16 by fitting, screwing or other means. This first cylindrical end 36.1 has an axis A36.1.

According to one arrangement, the connection tube 36 is arranged to extend the cavity 34 in the longitudinal direction.

According to one embodiment, the body 30 has a second face 32′ parallel to the first face 32, and a peripheral face 38 linking the first and second faces 32, 32′.

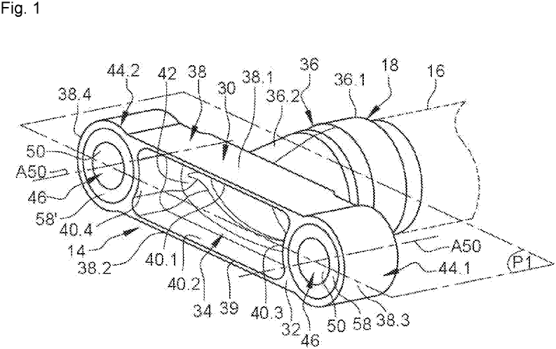

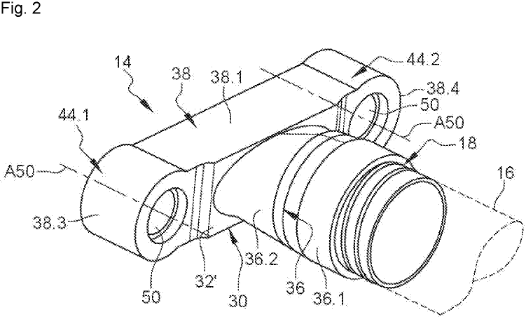

According to an arrangement shown in FIGS. 1 and 2, the body 30 has an oblong section in the transverse planes positioned between the first and second faces 32, 32′. According to this arrangement, the peripheral face 38 has two flat portions 38.1, 38.2 that are parallel with one another, and two semi-cylindrical end portions 38.3, 38.4 linking the flat portions 38.1, 38.2.

The cavity 34 forms a suction mouth 39 in the first face 32. This suction mouth 39 is the intersection of the first face 32 and the cavity 34. In a transverse plane, the cavity 34 and the suction mouth 39 have an oblong or elongate section. According to one arrangement, the cavity 34 is delimited by two flat surfaces 40.1, 40.2 that are parallel to one another, substantially parallel to the flat portions 38.1, 38.2, and barely spaced apart from these latter, as well as by two end surfaces 40.3, 40.4 spaced apart from two semi-cylindrical portions 38.3, 38.4 of the peripheral face 38.

Naturally, the disclosure herein is not limited to these sections for the peripheral face 38 and the cavity 34.

Furthermore, the body 30 has first and second heads 44.1, 44.2 arranged on each side of the oblong suction mouth 39 and extending the first and second ends thereof.

According to the arrangement shown in FIGS. 1 and 2, the first head 44.1 is positioned between the first end portion 38.3 of the peripheral face 38 and the first end surface 40.3 of the cavity 34. In parallel, the second head 44.2 is positioned between the second end portion 38.4 of the peripheral face 38 and the second end surface 40.4 of the cavity 34. The first and second heads 44.1, 44.2 are therefore positioned on each side of the axis A36.1 of the first cylindrical end 36.1 of the connection tube 36 in a transverse direction. Combined with the fact that the connection tube 36 is arranged to extend the cavity 34 in the longitudinal direction, this arrangement provides a compact suction nozzle 14.

The cavity 34 has a bottom 42 that has an orifice communicating with the second end 36.2 of the connection tube 36. The second end 36.2 and the bottom 42 of the cavity 34 have sections that evolve from a circular section to an oblong section in this case, and are designed to limit the head loss between the cavity 34 and the first cylindrical end 36.1 of the connection tube 36. The body 30 is integral with the connection tube 36 of the suction nozzle 14 and made of a rigid material such as metal or a composite material.

The particle suction device 10 has at least one fastening system 46 that includes at least one linking element 48 rigidly connected to the support 20, as well as at least one seat 50 that is rigidly connected to the body 30 of the suction nozzle 14 and designed to receive the linking element 48.

According to one embodiment, each linking element 48 has a cylindrical body 52 that has an axis A52, a first end 52.1 designed to be linked to the support 20 and a second end 52.2 designed to be seated in the corresponding seat 50 of the body 30.

The cylindrical body 52 has a first shoulder 54 at the first end 52.1 thereof, positioned in a plane perpendicular to the axis A52 and designed to bear against a surface S20 of the support 20.

According to a first arrangement, the cylindrical body 52 has a second shoulder 56 positioned in a plane perpendicular to the axis A52 parallel to the first shoulder 54 and separated by a given distance from the first shoulder 54. The cylindrical body 52 has a first diameter D1 from the second shoulder 56 in the direction of the second end 52.2 as well as a second diameter D2, that is greater than the first diameter D1, from the second shoulder 56 in the direction of the first end 52.1.

By way of example, the first and second shoulders 54, 56 are separated by a distance of between 30 mm and 100 mm. This distance must enable the passage of at least a portion of the tool 22, notably the active portion 22.1 thereof.

When in operation, when the linking element 48 is rigidly connected to the support 20, the first shoulder 54 thereof is pressed against the surface S20 of the support 20, the axis A52 thereof is perpendicular to the surface S20 and the second shoulder 56 is parallel to the surface S20 and separated from this latter.

According to a second arrangement, the cylindrical body 52 has at least one slightly tapered section between the first and second ends 52.1, 52.2 with a diameter that lessens towards the second end 52.2. According to a first arrangement, the tapered section extends from the first end 52.1 to the second end 52.2. According to a second arrangement, the tapered section is spaced apart from the first shoulder 54.

According to one embodiment, each linking element 48 is an assembly pin used in the domain of aircraft construction.

Regardless of the arrangement, the geometry of the cylindrical body 52 is a shoulder, a tapered section or otherwise, enabling the suction nozzle 14 to be held at a given distance from the support 20 to enable the passage of at least one active portion 22.1 of the tool 22.

Each seat 50 has a cylindrical shape, traverses one of the heads 44.1, 44.2 of the body 30, opens out in the first and second faces 32, 32′ of the body 30, and has an axis A50 approximately perpendicular to the first face 32.

According to one embodiment, for each seat 50, the suction nozzle 14 has at least one cylindrical tubular insert 58 made of an elastomer that has an inner wall forming the seat 50 and an outer wall rigidly connected to the body 30 of the suction nozzle 14. The disclosure herein is not limited to this material for the insert 58, which can be made of any other elastically deformable material, such as rubber, silicone, thermoplastic polyurethane, or thermoplastic elastomer.

For each insert, the body 30 has, in one head 44.1, 44.2, a through-hole 60 that has a first section 60.1 opening out in the first face 32 and having an inner wall cooperating with the outer wall of the insert 58 and a second section 60.2 opening out in the second face 32′ and having a diameter less than the diameter of the first section and greater than the first diameter D1 of a linking element 48, the first and second sections 60.1, 60.2 being linked by a shoulder 60.3. The length of the first section 60.1 is substantially equal to the length of the insert 58 so that the insert is flush with the first face 32 when in contact with the shoulder 60.3.

According to one arrangement, each insert 58 has a constant cross section along the entire length thereof (dimension measured in the longitudinal direction). In parallel, the first section 60.1 has a cross section that is constant along the entire length thereof and identical to the cross section of the insert 58.

Each insert 58 is linked to the body 30 by gluing or any other assembly technique. Each insert 58 is therefore linked to the body 30 by a full link.

According to another embodiment, the body 30, the connection tube 36 and the inserts 58, 58′ of the suction nozzle 14 are made integral with one another using a three-dimensional printing technique incorporating two different materials. By way of example, the body 30 and the connection tube 36 are made of polylactic acid (PLA) or acrylonitrile butadiene styrene (ABS) and each insert 58, 58′ is made of thermoplastic polyurethane.

The insert 58 and the linking element 48 are not necessarily cylindrical. The insert 58 and the linking element 48 are arranged to form a tight fit. ‘Tight fit’ means that there is no play between the insert 58 and the linking element 48, but the insert 58 can be fitted by hand on the linking element 48, and that, once fitted, the insert 58 is immobilized in relation to the linking element 48 at a distance from the surface S20 of the support 20.

The use of an elastomer tubular insert 58 and a linking element 48 enables the suction mouth 39 to be positioned near to the zone to be machined, even if the surface about the zone is not flat. The use of an assembly pin as linking element 48 obviates the need to develop and manufacture a specific part to hold the suction nozzle 14.

According to one embodiment, each of the first and second heads 44.1, 44.2 has a through-hole 60, 60′ in which a tubular insert 58, 58′ designed to receive a portion of a corresponding linking element 48 is positioned. The suction nozzle 14 is then linked to the support 20 by two linking elements 48, 48′ positioned at the ends of the suction mouth 39. This solution provides high stability for the suction nozzle 14 and enables the suction mouth 39 to be positioned as close as possible to the zone to be machined, even if the surface about the zone is not flat.

The fact of using elastomer inserts 58, 58′ enables the inserts to be fitted on two linking elements 48, 48′, even if these linking elements are not perfectly parallel with one another, or if the center-to-center distance between the two linking elements 48, 48′ is not exactly equal to the center-to-center distance between the inserts 58, 58′.

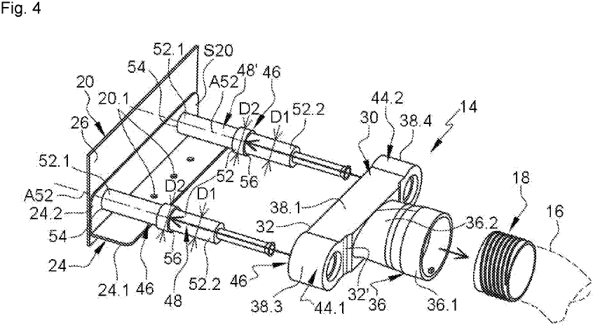

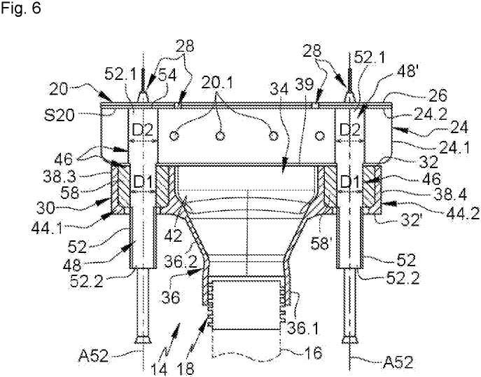

As shown in FIGS. 4 to 6, installation is relatively simple. Firstly, the linking elements 48, 48′ are rigidly connected to the support 20, notably to the second flange 24.2 of the L-shaped angle iron 24. Secondly, the suction nozzle 14 connected to the pipe 16 is positioned so that the inserts 58, 58′ are arranged to extend the linking elements 48, 48′, as shown in FIG. 4. The inserts 58, 58′ are then fitted onto the linking elements 48, 48′ until the inserts are blocked. The suction nozzle 14 is then positioned at a distance from the support 20 and connected thereto, as shown in FIGS. 5 and 6. The stock removal operation can then be performed using the tool 22, as shown in FIG. 5.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A particle suction nozzle comprising a body having a first face, a cavity opening out in the first face to form a suction mouth as well as a connection tube communicating with the cavity, the suction nozzle having at least one portion of a fastening system to link the nozzle to a support, wherein the fastening system has at least one tubular insert made of elastically deformable material, rigidly connected to the body, the insert forming a seat configured to receive a linking element rigidly connected to the support, the insert and the linking element forming a tight fit to enable the insert to be fitted on the linking element, the insert, once fitted, being immobilized in relation to the linking element and at a distance from the support.

2. The particle suction nozzle according to claim 1, wherein each insert has an outer wall and wherein the body has, for each insert, a through-hole that has a first section opening out in the first face and having an inner wall cooperating with the outer wall of the insert and a second section having a diameter less than a diameter of the first section, the first and second sections being linked by a shoulder.

3. The particle suction nozzle according to claim 2, wherein a length of the first section is substantially equal to a length of the insert so that the insert is flush with the first face when in contact with the shoulder.

4. The particle suction nozzle according to claim 1, wherein the suction mouth has an oblong shape and first and second ends, and wherein the fastening system has two inserts positioned at the ends of the suction mouth as well as two linking elements each configured to be rigidly connected to the support and to cooperate with one of the two inserts.

5. The particle suction nozzle according to claim 4, wherein the body comprises first and second heads positioned on each side of the suction mouth and extending the first and second ends thereof, in which the inserts are positioned.

6. The particle suction nozzle according to claim 1, wherein the connection tube is positioned to extend the cavity in a direction perpendicular to the first face.

7. A suction device including a particle suction nozzle according to claim 1.

8. The suction device according to claim 7, wherein the suction device includes, for each insert, a linking element configured to be rigidly connected to the support and to be seated in the seat formed by the insert.

9. The suction device according to claim 8, wherein each linking element is an assembly pin.

10. The suction device according to claim 8, wherein each linking element comprises a cylindrical body that extends between the first and second ends, the cylindrical body having a first shoulder positioned at the first end thereof and configured to bear against a surface of the support.

11. The suction device according to claim 10, wherein the cylindrical body has a second shoulder parallel to the first shoulder and separated by a given distance from the first shoulder, the cylindrical body having a first diameter from the second shoulder in a direction of the second end as well as a second diameter, that is greater than the first diameter, from the second shoulder in a direction of the first end.

12. The suction device according to claim 10, wherein each linking element has at least one slightly tapered section between the first and second ends with a diameter that lessens towards the second end.
